(19) United States
(12) Patent Application Publication
(10) Pub. No.: US 2020/0402419 A1
(43) Pub. Date: Dec. 24, 2020

(54) SYSTEM AND METHOD FOR AUTOMATICALLY RECOGNIZING ACTIVITIES AND GAZE PATTERNS IN HUMAN PATIENT SIMULATIONS

(71) Applicant: Cleveland State University, Cleveland, OH (US)

(72) Inventors: Wenbing Zhao, Avon, OH (US); William A. Matcham, Elyria, OH (US)

(21) Appl. No.: 16/907,496

(22) Filed: Jun. 22, 2020

Related U.S. Application Data
(60) Provisional application No. 62/864,897, filed on Jun. 21, 2019.

(51) Int. Cl. G09B 19/00; G06T 11/00; G06T 7/246; G06K 9/00; G09B 9/00

(52) U.S. Cl. CPC G09B 19/003; G06T 11/00; G06T 7/246; G06T 2207/30201; G06K 9/00671; G09B 9/00; G06T 2207/30204; G06K 9/00342

(57) ABSTRACT

A system and method automatically recognizes complex activities and gaze patterns. One particular application of the system and method is the recognition of the activities and gaze patterns of a nursing student who practices nursing skills during human patient simulations (HPS). Accordingly, the system and method provide a novel event-drive context model for complex human activity and gaze recognition. The system and method include the identification of all necessary context and the development of an ontology for HPS to recognize complex activities in HPS, the encoding of correctness rules for skills in HPS, automated identification of errors made by the student during a simulation session, and the development of personalized feedback based on the data collected during a session and the predefined correctness rules. The system and method also incorporates a marker-based mechanism that facilitates privacy-aware tracking wherein only a consented user will be monitored.

### RELATED APPLICATION

This non-provisional utility patent application claims priority to and the benefits of U.S. Provisional Patent Application Ser. No. 62/864,897, filed on Jun. 21, 2019, and entitled “System and Method for Automatically Recognizing Activities and Gaze Patterns in Human Patient Simulations,” which application is incorporated herein by reference, in its entirety.

### BACKGROUND

The US is experiencing a dramatic shift in demographics, and people older than 65 years are expected to outnumber those younger than 5 years in 2019. As Americans age and live longer, increasing numbers of them will live with multiple chronic conditions, such as mild cognitive impairment or dementia. One of the greatest health care challenges facing our country is ensuring that older citizens with serious chronic illness and other conditions of aging can remain as independent as possible while controlling the cost of healthcare. Evidence has shown that home-based care (aging in place) would be an effective means to meet this challenge because patient satisfaction is higher and the cost is lower than hospital-based cost. Hence, in future work of nurses, home-based care would be a significant component and new technologies will be developed to facilitate them to provide high quality care to patients.

Moreover, healthcare reform has dramatically affected how care is delivered to patients. Patients are much sicker with multiple complex conditions when they come to the hospital. Length of stay in hospitals has been reduced with much of the rehabilitation and follow up care occurring in the community setting or individual homes. This shift saves money, prevents nosocomial infections and reduces patient/family burden by allowing recovery in familiar settings with loved ones. The shift to a home care model makes sense for fiscal and psychological reasons, but may actually place the patient in higher danger of complications due to poor compliance with treatments, lack of assessment to detect changes in health status and infection risk due to unhygienic environments. Home care nurses have the opportunity to care for patients in their home, but they must be properly prepared to deal the special environments that occur.

Home care nursing has to handle the personal environment as it exists in an individual's home. The individual nurse interacts with the patient alone, with no technical or medical support and only the equipment they bring. Home environments, especially of elders with chronic conditions and limited mobility, may be less than clean, pose many hazards and may contain toxins, germs, rotting food, dirt or clutter and lack the space or facilities for proper patient care. The home care nurse must navigate the complexities of physical environment, patient expectations, family demands and medical needs using limited supplies and no support. Due to the multifactorial role of the home care nurse, they must have high levels of autonomy, superb time-management skills, high self-efficacy and be able to adapt rapidly using innovative problem solving techniques.

Human patient simulation (“HPS”), is a training method in which learners practice tasks and processes in lifelike circumstances using models. HPS allows nurses to practice in a safe environment to build clinical proficiency at new tasks. HPS has been used for over 40 years in medical and nursing education, and is also applicable to sectors of the medical profession and beyond—including engineering, the service industry, education, athletics and more. While HPS has been accepted as the most effective way of training future nurses, there is a need for a quantitative approach to experimental design that maximizes its impact to student learning in genera. Further, there is a need for an enhancement to HPS that will solve its existing deficiencies and allow it to fill the other gaps in nursing and other education, especially regarding home care.

### SUMMARY

According to an embodiment, a system for training a trainee, the system includes mixed-reality hardware, wearable by the trainee and having a display viewable by the trainee, a camera coupled to a tracking logic, an object of interest, the object of interest having a marker associated therewith; and a training logic. The mixed reality hardware is configured to track a position of the object of interest based on the marker, on the display, overlay an image onto the object of interest based on the marker, detect whether the trainee is gazing at the object of interest, and detect human speech. The tracking logic is configured to track skeletal movements of the trainee. The training logic is configured to provide feedback to the trainee regarding training progress based on tracking of the object of interest, detecting whether the trainee is gazing at the object of interest, detecting human speech, and tracking the skeletal movements of the trainee.

### BRIEF DESCRIPTION OF DRAWINGS

FIG. 1 is an exemplary flow chart showing a system and method for training according to the present disclosure.

FIG. 2 is an image of an exemplary hologram overlaid onto an exemplary object of interest according to the present disclosure.

FIG. 3 is a flowchart illustrating an exemplary method for gaze and object detection according to the present disclosure.

FIG. 4 is a system diagram illustrating an exemplary training context model according to the present disclosure.

FIG. 5 is a flowchart illustrating an exemplary decision-making model for training feedback according to the present disclosure.

FIG. 6 is a flowchart illustrating an exemplary training model according to the present disclosure.

FIG. 7 is a flowchart illustrating an exemplary model for improving self-efficacy during training according to the present disclosure.

### DETAILED DESCRIPTION

The present disclosure relates to a context-specific HPS to train personal, e.g., nurses who are transitioning to home care with clinical skills needed to provide high quality home-based care. This system and method will fill the gaps in nursing education by helping to train nurses that can independently use technologies confidently and competently and who are capable of handling challenging situations associated with home care.

Normal acute care nurses are not trained to work in this type of environment and need extensive training to transition to home care. With more and more care being offered in the home, there is a lack of qualified home care nurses that possess the needed skills and experience to provide complex care in the home. Some of the unique skills of the home care nurse includes: (1) large loads for case management of complex patients with many chronic conditions and demanding families; (2) working in isolation without interprofessional teams or equipment support such as phlebotomy; (3) lack of technical support when equipment fails in the home; (4) ability to complete assessment of the community, home and home care environment for hazards; (5) managing interprofessional tam dynamics of working with physicians, therapist and other home care providers that may have competing priorities; (6) home infusion skills; (7) bag techniques; (8) complex wound care including staging and wound vac changes; (9) management of diabetic ulcers; (10) polypharmacy medication management and therapeutic regimes; (11) extensive education on medical and non-medical topics related to care.

To excel in providing home-based care, a nurse must possess a high degree of self-efficacy in multiple dimensions. While it is apparent that nurses must have excellent clinical skills, clinical judgement and critical thinking appropriate for home-based care, they must also be equipped with adequate non-clinical skills to tackle the non-medical situations and emergencies. In the context of future work, technology will play an even more important role in the homebased care where a nurse is faced with greater challenges, higher workloads, and more complex patients. For example, a nurse must have high self-efficacy to handle technologies on the job and possess good leadership skills when interacting with patients to handle unexpected crisis.

Home based care is a specialized segment of nursing that requires integration of experience from many skills, including emergency care, advanced assessment, problem solving, creative thinking and time management. Current nursing education programs in the nation focus on training students to be general practitioner nurses in acute care settings who can pass the licensure exams, not specialists in home based care.

Current nursing education programs suffer from several educational gaps, four of which are discussed herein. First, the knowledge and skills taught in the nursing curriculum are geared towards providing care in institutions such as hospitals and clinics, which are very different from the home-care environment. Second, most nursing programs have incorporated informatics courses in their curriculum to teach nurses how to use the technology of today, such as electronic medical records. These course materials are focused on basic informatics that are currently employed in the healthcare systems. As a result, the effort is inadequate and inconsistent to prepare future nurses to adapt and embrace various technologies in their future work environments. As technology advances and permeates the medicine and healthcare industry, technology-induced stress, or technostress, is becoming a serious issue impacting the nursing industry as the technostress could lead to lower quality care for patients and high burnout and turnover rates among nurses. Third, with the focus on basic nursing skills, there is insufficient effort to equip future nurses with adequate clinical leadership skills to deal with the multiple variate, complex problem solving necessary to function with the patients and potentially their family members and to handle unexpected situations.

Although the second the third gaps are also relevant for hospital-based care, the gaps are more prominent for home-based care because visiting nurses are left to handle the technologies and potentially crisis situations alone without support from onsite IT experts and healthcare teams.

The fourth gap concerns HPS. Approximately 500 nursing programs are using HPS to train students. The disadvantage (or fourth gap) in HPS is the lack of reliable and efficient methods to provide objective assessment and feedback to students in real time. The current practice includes direct faculty observation during simulation, or videotaping the entire simulation and then having the instructor watch the videotape together with the student to provide feedback about the student performance. Both practices are very time and resource intensive and only provide subjective opinions of the instructors.

While home care nursing is just one specific application of the disclosed system and method, it highlights a need for technological advancement for simulation training techniques in general. The type of human and environmental interactions that are so prevalent in home-care nursing are also present in other sectors of the medical profession and beyond—including engineering, the service industry, education, athletics and more. Accordingly, the same types of gaps described above for home nursing care exist also in other HPS applications and even beyond HPS to simulation training in myriad other professions. All such simulation training could benefit from the same types of improvements that would enhance HPS.

In recent years, computer vision has made significant leaps in human skeleton tracking (e.g., the OpenPose framework), which can perform skeleton tracking of multiple users with a regular webcam. Based on the skeleton data, one can make reliable recognition of human poses and actions, such as standing, sitting, walking, and reaching (with a hand). However, how to recognize complex human activities remains an open issue, which consists of a sequence of actions in particular contexts. The context is typically established by the environment of the action, such as one or more objects that the person is reaching to or gazing at. The context of the activities and the sequence of actions are inevitably application dependent. While it may be straightforward to automatically identify a complex human activity when it is performed perfectly, it is much more challenging to recognize similar activities with incorrect actions and/or objects in the environment. Identifying a wrong activity while pinpointing exactly what was wrong could be of great value in many applications.

While self-efficacy has been touted as the cornerstone towards increasing job performance, coping with technostress, and developing leadership, there has been little work on identifying key parameters that help promote one's self-efficacy. Studies have reported positive correlations between self-efficacy and job performance, reducing technostress, and leadership based on the social cognitive theory, and have found that judgments of self-efficacy are based on performance attainments, vicarious experiences of observing the performances of others; verbal persuasion, and physiological states, which are a reflection of one's capability, strength, and vulnerability. These are only high-level principles, however, that may affect a person's perception of self-efficacy. How to map these principles to concrete measures in the context of nursing education and, in particular, how to use technology to facilitate positive impact on self-efficacy, has not been addressed previously.

As disclosed herein, a suite of HPS scenarios is augmented with mixed reality technology to simulate work environments that can be readily adapted to include future technology. An automated method objectively assesses the performance of nurses and provides real-time feedback with visual cues and audio speech, when appropriate, during HPS using computer vision and live data stream processing. As a result, cognitively-informed nursing education and technology-enhanced training can augment nurses' self-efficacy, which is crucial for them to excel in the professional workplace with the right skills, attitude, confidence, and leadership. While the present disclosure focuses on home-based care, the systems and methods herein are applicable to general nursing education and healthcare in general. To that end, the present disclosure provides a novel set of systems and methods for activity and gaze recognition by combing gaze tracking, skeletal motion tracking, object recognition, voice recognition, ontology and fuzzy logic. Moreover, a theoretical framework is provided towards the conceptual understanding of self-efficacy for technology-facilitated nursing education and the framework is tested with empirical data. Finally, the disclosure provides identification of optimal conditions, informed by cognitive psychological science, enabled by the data collected via technology, for the training of nurses in HPS that are well equipped to provide high quality care in home-based care.

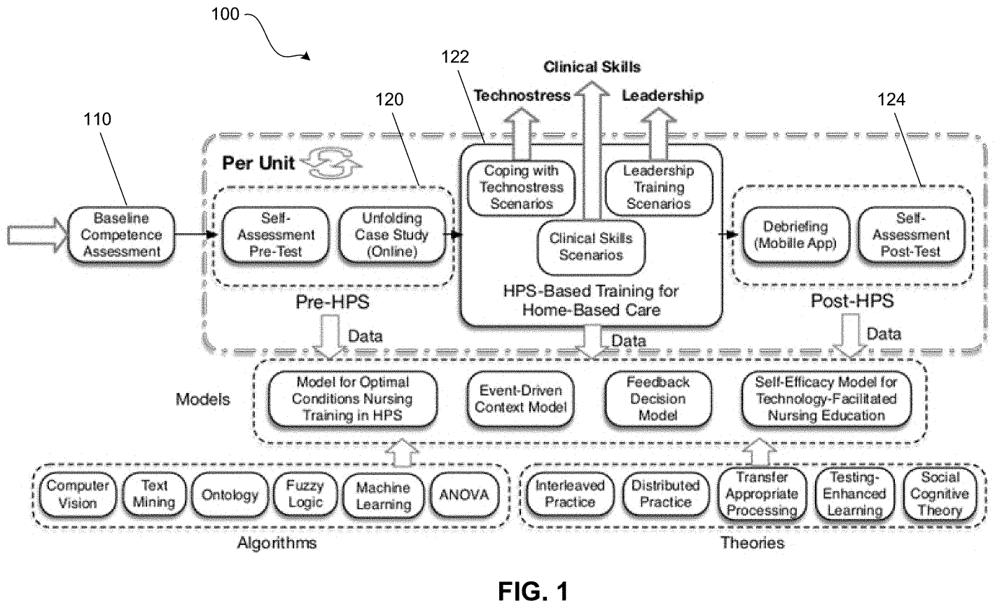

FIG. 1 depicts and exemplary embodiment of a training method and system 100 having multiple layers of training and evaluation. Before the training begins, nurses will complete a baseline of competence assessment 110, having, for example, a general self-efficacy evaluation and a Pretest for Attitudes Towards Computers in Healthcare (P.A.T.C.H). Each study unit will cycle through the pre-HPS 120, HPS 122, and post-HPS 124 stages. In the pre-HPS stage 120, nurses participate in didactic training scenarios offered through an online, unfolding case study platform presented in a ‘chose your own adventure’ format. This format will allow nurses to explore different decision pathways, and refine clinical problem solving, in a safe, online environment. The case studies components will consist of short video vignettes, interactive games, audio recordings of workplace sound and patient comments, critical thinking questions, clinical decisional pathways support, and various patient outcomes based on decisions. System generated feedback will help guide nurses through the decision-making process to improve self-efficacy and help teach the basics of clinical competence and leadership. Once basic knowledge, skills, and attitudes are established, nurses will participate in simulated scenarios to apply what they have learned. This procedure will prepare students' cognitive knowledge and analytical skills so that they are ready to practice and to be tested in realistic scenarios with HPS.

The HPS stage 122 includes scenarios designed to mimic common workplace situations experienced by home-care nurses. Student competency will be assessed using a technology-enhanced error-detection system and computer vision with real-time audio and visual feedback. A software application (e.g., for a mobile device, software as a service, etc.) for individualized debriefing and self-efficacy assessment accompanies the simulations. This mobile software application provides detailed feedback to students, to provide an opportunity for students to do self-reflection, and to assess students' self-efficacy in the three major dimensions (clinical skills, technostress, and leadership) at the post-HPS stage.

Data may be collected during the pre-HPS stage 120, HPS stage 122, and post-HPS stage 124 via various technologies, including text-mining (during pre-HPS stage 120), computer vision for activity recognition, ontology, real-time decision making based on fuzzy logic and machine learning (during HPS stage 122 and post-HPS stage 124), and statistical methods such as t-test and ANOVA for pre-test and post-test self-efficacy assessment. Furthermore, machine learning based on the data collected can be used to develop personalized models that offer the best guidance to each individual so that each can improve her or his self-efficacy in an optimal way. The data will also enable study of the cognitive mechanisms that help build-up self-efficacy in the context of nursing education. Furthermore, the data could also inform nursing curriculum design to better prepare nurses to be clinical leaders and technology innovators.

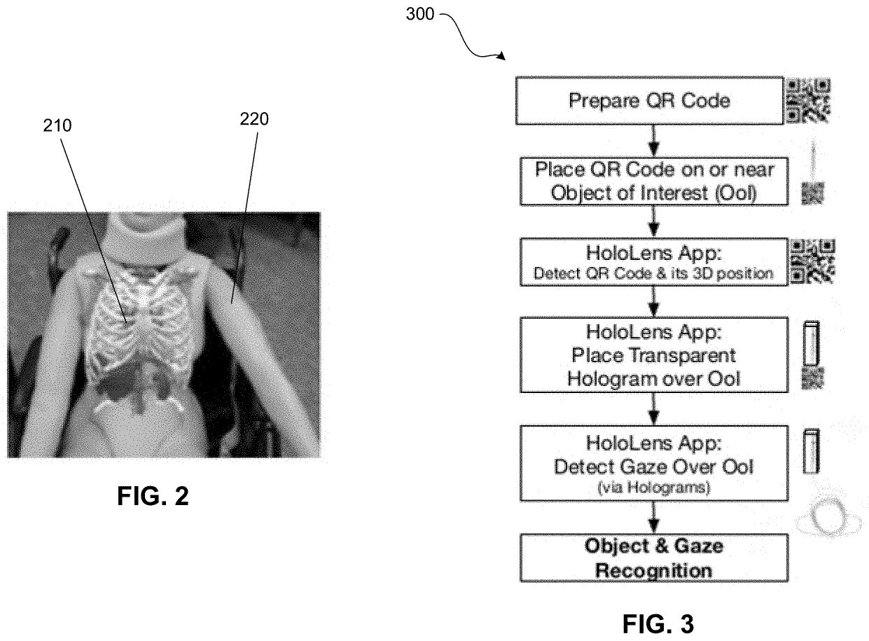

In an exemplary embodiment, systems and methods include use of mixed reality technology (e.g., the Microsoft HoloLens) to enhance HPS. Mixed reality devices achieve mixed reality via sophisticated depth sensing of the physical environment and holographic display where a user can see both the physical environment as well as digital objects (referred to as holograms) rendered in three dimensions holographically. The present disclosure extends this technology with (1) recognition of arbitrary objects and (2) overlaying of 3D holographic objects (i.e., holograms) on physical objects/places of interest. An example hologram overlay 210 on top of a mannequin 220 is shown in FIG. 2. A reason for enabling both is the use of indirection for object recognition. Despite advances in computer vision technology, it is still impossible to accurately detect arbitrary objects reliably in real time. This problem can be solved, however, by attaching to each object of interest (OoI) a pre-prepared marker, which can be easily recognized using a camera with existing libraries. By recognizing the marker, by association and the content encoded in the marker, the OoI can be reliably and accurately recognized in real time.

Major steps for arbitrary object and gaze recognition are illustrated in the flowchart 300 of FIG. 3. This indirection-based object recognition scheme is well suited for HPS, where all objects in a simulation are carefully planned and placed at the desirable locations.

This present technology can thus be used to overlay 3D holograms on top of a mannequin to simulate patient conditions. This could prove to be tremendously helpful in creating human patient simulations that previously could only be done with high-end mannequins, which are very costly. Especially for lower-cost mannequins, some patient conditions require manual manipulation, which incurs high cost in human resources. The availability of this overlay functionality for lower-cost mannequins could make it possible to simulate patient conditions automatically, which reduces the cost of both mannequins and the operator cost. By placing a QR code on the desirable location of a mannequin 220, we have demonstrated that it is possible to overlay a hologram 210 for 3D anatomy on the chosen location, as shown in FIG. 2.

According to an embodiment, systems and methods may use a software development kit (SDK) to interface with the mixed-reality technology. One such exemplary SDK is Vuforia, which is designed for mobile use. A suitable SDK preferably includes good integration with existing 3D environment development platforms (e.g., Unity). A suitable SDK also preferably includes a marker tracking solution, including object, cylinder, and picture trackers.

Once a marker is detected, the SDK returns the marker content as well as its 3D position. In some embodiments, enhanced marker tracking technologies may be integrated with the system to increase speed and accuracy, and to decrease the size of the markers required, for example, ArUco tracking markers.

Preferably, the SDK further includes a gaze tracking API (Application Program Interface) that detects if a person is looking at a hologram. As shown in FIG. 3, if a hologram (sometimes an invisible one to the user if so desirable) is overlaid on top of an OoI, the system and method can provide continuous gaze tracking and receive information regarding exactly which object the user is looking at and for how long. This enables automatic gaze tracking to uncover the cognitive mechanisms during HPS sessions.

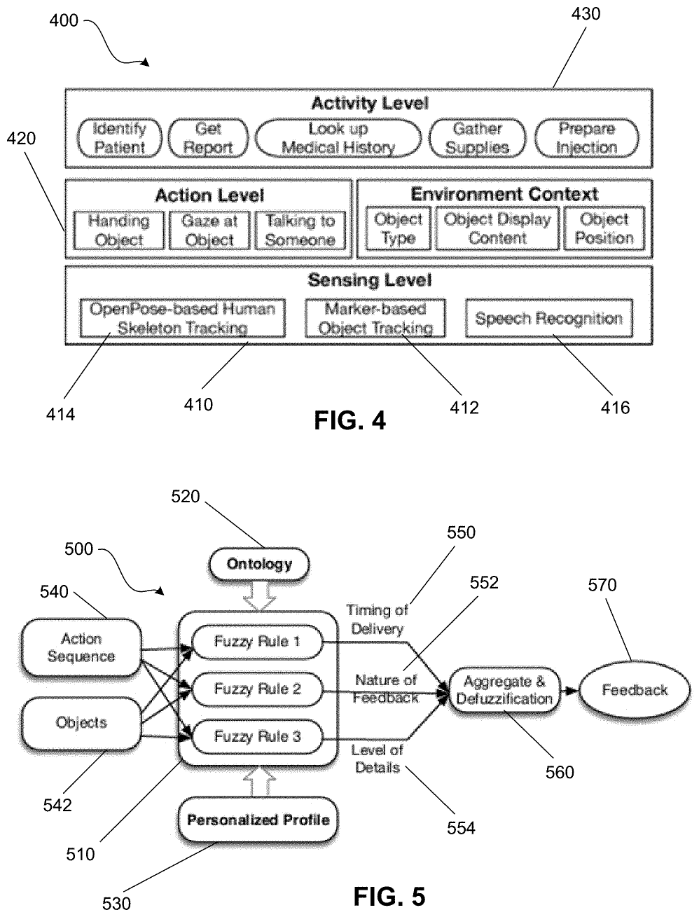

As illustrated in FIG. 4, an event-driven context model 400 is used to for activity and gaze recognition in HPS according to the present systems and methods. In one embodiment, the event-driven context model has three levels. At the bottom is a sensing level 410, which uses different sensors to detect human action, including via skeleton tracking 414, gaze tracking, object tracking 412 and speech recognition 416. The middle level is an action level 420 that determines human actions based on computer vision (specifically, handing objects, gazing at objects and talking to a person) and the states of environment objects (such as the object's position and type). In the third and the highest layer, an activity layer 430, human activities are inferred based on detected human actions and the states of the environment objects and a predefined ontology for medical care.

Application of this context model in HPS involves several challenges. For example, a correct activity could be the direct handling of the correct medical object (such as a syringe with the correct amount and correct type of medicine), or examining the patient ID band as worn by the patient on the wrist by placing a hand around the ID band and gazing at the ID band, or asking the patient to confirm his or her name and birthday. This means that the context needed to recognize an activity includes the recognition of objects (such as the correct syringe), the recognition of speech, which object the student is gazing at, and the relative position between a hand and the target object. This in turn dictates that multiple sensing modalities are needed to establish the context, for example human skeleton tracking (such as for head and hand position), gaze detection, object recognition (not merely the state of the object), the position of the object, and voice collection. The ontology is preferably specific to HPS.

Using a marker-based approach at the sensing level 410 helps solve these challenges. An exemplary sensing level 410 includes four types of sensing. Marker-based object tracking 412 is achieved by placing a small marker on medical objects or on the desirable locations on a mannequin, the system and method can reliably recognize the objects and their positions in real time. Some objects may already have a marker, which could be recognized directly. Human skeleton tracking 414 can be accomplished using regular RGB via existing frameworks, for example, the OpenPose framework, or a depth camera such as Microsoft Kinect. If appropriate cameras are used, skeleton tracking for large area can be achieved. Gaze detection (not specifically shown in FIG. 4) can be done via the mixed-reality API discussed earlier or a specialized gaze tracking headset such as those from Tobbi. Speech recognition 416 can also rely on the mixed-reality API, or a separate speech recognition program can be used.

Another aspect of the system and method provides feedback in real time to a student while she or he is practicing in an HPS. The type of feedback provided and the timing to deliver the feedback help to shape one's self-efficacy and ultimately the competence of the student. While it may be straightforward to automatically identify a complex human activity when it is performed perfectly, it is much more challenging to recognize similar activities with incorrect actions and/or objects in the environment. Identifying a wrong activity while pinpointing exactly what was wrong could be of great value in many applications.

FIG. 5 depicts an exemplary model 500 that captures possible sequences of actions and related environmental states. According to this proposed model, all decisions on feedback are made by a fuzzy logic rule engine 510. The fuzzy logic rule engine 510 includes one or more rules that are based on an ontology 520 for the simulated skills and a personalized profile 530, which, as described in more detail below, is developed for each student. This means that the fuzzy logic rules are customized for each student, which best reflects the preferences, personality, and current progress of the student. As the student progress during the course of their education, the profile for the student will gradually change and the rules will be changed accordingly. The input to the engine is the observation of the student's behavior in an HPS, as reflected as the action sequence 540 and the objects in the environment 542. The output from the engine includes the timing of delivery 550, the nature of feedback 552 (i.e., positive or negative), and the level of details of the feedback 554. Then, the outputs are aggregated and defuzzied 560 to derive the final feedback 570 to the student.

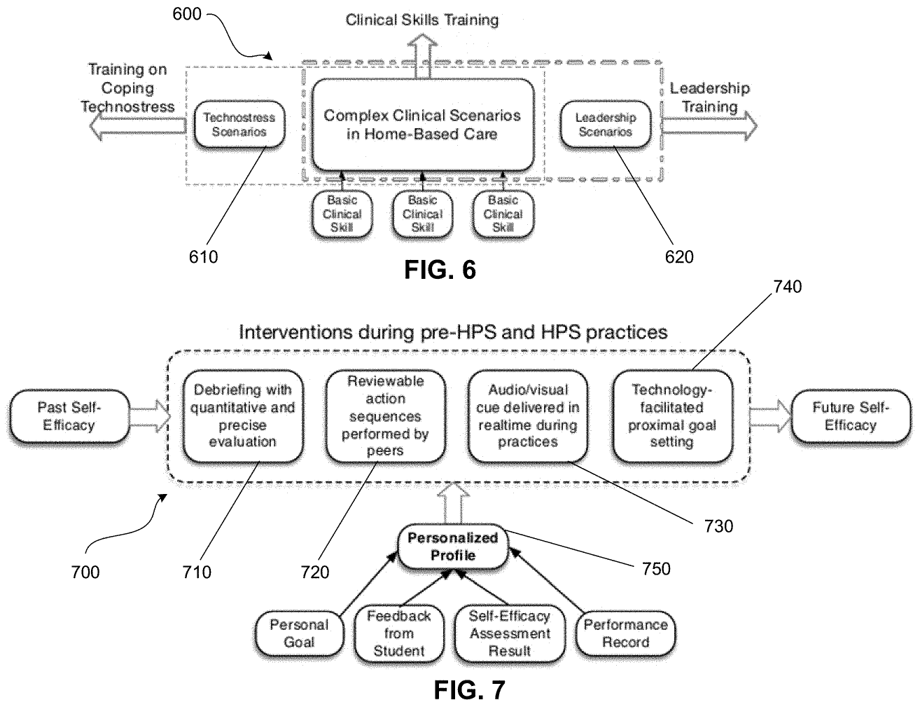

FIG. 6 illustrates an exemplary set of clinical scenarios 600 for home-based care to be used for HPS-based training. These clinical scenarios are composed by simulations for basic clinical skills. To train students on coping technostress, additional technostress scenarios 610 are created in the context of complex clinical scenarios. Similarly, leadership training scenarios 620 are designed in the context of complex clinical scenarios to train students for leadership. HPS can run in three modes: (1) Teaching mode, with step-by-step explanation, will walk students through each essential step of the task and provide explanations and rationale. Video instruction, providing “just in time” training, will supplement checklists and critical thinking questions. (2) Practice mode will provide less instruction with a modified time to complete the task. Practice mode provides more critical thinking questions and forces students to defend the rationale for actions, allowing students to independently engage in repetitive practice to master a skill that can be transferred to different situations. Practice mode can also be used for remediation of students who need additional practice after making a mistake in a clinical area or being unsuccessful on a skill checkoff. (3) Testing mode provides no instruction or hints and runs in real time to simulate actual nursing workflow. The student is assessed with a score on how well each step is performed as well as the ultimate outcome of the task.

In one embodiment, a series of computer based, skills scenarios are presented as unfolding case studies to allow nurses to navigate a learning platform in a ‘choose your own adventure’ format. This allows nurses to explore action and reaction consequences based on clinical decisions made. The scenarios help reinforce both “hard” nursing skills such as assessments and blood draws in addition to “soft” skills such as problem solving, decision making, leadership, team dynamics and self-efficacy. Other skills that may be addressed include phlebotomy, intravenous (IV) starts and IV infusion (including medication calculation and dosing), polypharmacy management and pill box setup, bag technique, case management, interprofessional team dynamics, community and home assessment, home bound patient/family needs assessments, assessment and application of complex wound dressings, assessment, application and management of wound vac dressings, self-care and safety in the home care environment, supply storage and preparation.

The skills training is followed by a series of HPS in a laboratory setting to test for nursing skills competency while combining multiple skills into an interdisciplinary scenario that mimics realistic patient situations. The HPS training is technology augmented to provide error detection and audio/visual interventions during training. Final competency is established during a competency examination using a standardized evaluation technique.

Simulation of technostress in the industry is achieved by creating three types of scenarios: (1) work anxiety, (2) surveillance anxiety, and (3) relational anxiety. The work anxiety may be caused by several factors: (1) technology-enabled automation may evoke apprehension of losing power on the job or even job security, (2) technology might increase the perceived job complexity and workload due to the poor technology-human interface design or intrusion to the worker's spare time, and increase the perception of the job uncertainty due to constant upgrades of hardware and software, and (3) technology may cause alteration of work routines that a healthcare professional is used to, which could cause additional challenge of performing on the job. Surveillance anxiety is caused by the fact that technology typically could be used to monitor the activities of the healthcare professional. Relational anxiety is due to the worry that technology may negatively impact the patient and medical staff interaction.

Leadership is developed through specific educational activities and by modeling and practicing leadership competencies. There are many different interpretations on nursing leadership, from those that tie leadership with management positions, to those that focus on leadership characteristics. Hence, training materials according to the present system and method cover at least the following areas in addition to clinical skills (for which students are already receiving training): (1) interpersonal communication skills, (2) emotional intelligence, and (3) management skills.

These scenarios utilize interleaved practice by repeating skills in a single session while mixing them with other skills. For example, a student will need to interleave the practice of giving medications into several stages of a single scenario as they find different problems and treat them accordingly. This is similar to live situations where a nurse does not give a big handful of pills to each patient in the morning, but rather they dispense them throughout the day, as appropriate, and based on patient condition and assessment findings.

Simulations of these skills and scenarios incorporate various holographic components enabled by the mixed-reality technology. The holographic components can be roughly divided into the following categories: (1) overlay of key body parts with sufficient anatomy, such as deltoid muscle for giving a shot; (2) overlay of visible symptoms (from facial expression or skin condition) of common diseases and pain levels (such as what is needed to show the pain level of the patient in the “give-a-shot” skill (this overlay includes models of such symptoms based on an existing medical knowledge base for holographic rendering); (3) context-dependent questions displayed in a virtual screen for a student to answer for step-by-step training of basic skills; and (4) display of medication-specific information based on the barcode of the medication.

FIG. 7 depicts an exemplary intervention model 700 for improving self-efficacy in technology-related nursing education. The exemplary model 700 includes a number of interventions that help increase the self-efficacy of nursing students using the rich data collected during all the pre-HPS, HPS, and post-HPS stages for each study unit, and development of a personalized profile for each student based on the data collected at various stages. A “enactive mastery” intervention 710 includes debriefing with quantitative and precise evaluation of the performance in pre-HPS and HPS practices. Instead of subjective evaluation, the technology used herein makes it possible provide students with objective assessment on their performance in both pre-HPS and HPS stages. Furthermore, students are informed precisely which parts of the practice are done very well and which parts need improvement. A more accurate and precise feedback to the student helps her or him set more realistic perception of self-efficacy, which will lead to better performance, which in turn will lead to higher self-efficacy.

A “vicarious experiences” intervention 720 includes reviewable action sequences performed with better precision/quality by peer students with similar capacity. Students are categorized into different levels. If a student did not perform well in certain activities, the symbolized recorded activities of another student in the same level who performed well will be identified and replayed for the student to boost confidence (and learn from the replay). This intervention may also be administered during the debriefing stage. The present technology makes it possible for a student to enjoy vicarious experiences on demand when convenient for the student and as frequently as the student wishes. This convenience increases the impact of this factor on the improvement of self-efficacy.

A “verbal persuasions” intervention 730 includes audio/visual cues during pre-HPS and HPS practices on how to take the next step, and precise guidance on how to make improvements during debriefing. The technology makes it possible to provide automated guidance to a student in real time during pre-HPS and HPS practices, and offline during the post-HPS stage. Furthermore, such intervention is delivered at the time, with the right nature, and in the right form to best fit the student's profile. This customized real time intervention as a form of persuasion will enhance one's self-efficacy.

A “cognitive” intervention 740 includes technology-facilitated proximal goal setting based on past self-efficacy assessment result and current performance in practices. It has been shown that only when one sets a realistic goal (i.e., proximal goal), does the person have the right motivation to make efforts towards the goal. However, the current literature does not specify exactly how to set proximal goals. This gap is filled by by helping a student make realistic proximal goals based the data collected regarding the student's capability and performance.

An important parameter for the above-described interventions is the development of a personalized profile 750 for each student. The profile provides customized intervention and training for students. The profile takes input from multiple dimensions, including the personal goal of the student, direct and indirect feedback from the student (for example, from a debriefing software application), the result of the self-efficacy assessment taken after each HPS practice (as part of the debriefing step in the software application), and the student performance during the HPS practice.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. Accordingly, departures may be made from such details without departing from the spirit or scope of the applicant's general inventive concept.

1. A system for training a trainee, the system comprising:
mixed-reality hardware, wearable by the trainee and having a display viewable by the trainee;
a camera coupled to a tracking logic;
an object of interest, the object of interest having a marker associated therewith; and
a training logic;
wherein the mixed reality hardware is configured to:
track a position of the object of interest based on the marker,
on the display, overlay an image onto the object of interest based on the marker,
detect whether the trainee is gazing at the object of interest, and
detect human speech;
wherein the tracking logic is configured to track skeletal movements of the trainee; and
wherein the training logic is configured to provide feedback to the trainee regarding training progress based on:
tracking of the object of interest,
detecting whether the trainee is gazing at the object of interest,
detecting human speech, and
tracking the skeletal movements of the trainee.
